(19) United States
(12) Patent Application Publication
(10) Pub. No.: US 2024/0330948 A1
(43) Pub. Date: Oct. 3, 2024

(54) METHODS AND SYSTEMS THAT REGISTER A DIGITAL MEDIUM AND VERIFY A REGISTRATION OF A DIGITAL MEDIUM

(71) Applicant: Fujitsu Technology Solutions GmbH, München (DE)

(72) Inventor: Nikolaos Saklampanakis, München (DE)

(21) Appl. No.: 18/018,057

(22) PCT Filed: Dec. 23, 2021
(86) PCT No.: PCT/EP2021/087527

§ 371 Date: Jan. 26, 2023

(51) Int. Cl. G06Q 30/018

(52) U.S. Cl. CPC G06Q 30/018

(57) ABSTRACT

A method of registering a digital medium includes: receiving, by at least one peer of a permissioned blockchain network, a digital medium from and an identifier of a medium provider, wherein the digital medium includes at least one of: a digital picture, a digital audio, and a digital video; executing a smart contract to register the digital medium; verifying the identifier of the medium provider using the smart contract; determining a content identifier of the digital medium using the smart contract, wherein the content identifier is an identifier that uniquely identifies a content of the digital medium; generating a registration identifier corresponding to the digital medium using the smart contract; storing the registration identifier in a blockchain; and providing the registration identifier and the content identifier to a database.

### TECHNICAL FIELD

This disclosure relates to a method of registering a digital medium, a method of verifying a registration of a digital medium, and a computer program and a computer readable storage medium.

### BACKGROUND

How to verify an original owner of an asset such as a piece of art, a piece of music, a written document, a video, or any other type of a digital or real-world asset, has always been a challenge. In particular, since electronic devices can be used to easily multiply and distribute digital media of such assets electronically, a possibility of proof of ownership of an asset shown or comprised in such digital medium is even more urgently needed. An electronical way of proving an ownership of such medium, however, is usually prone to manipulation and, therefore, rather unreliable.

It could therefore be helpful to provide secure and reliable methods, systems, computer programs and computer readable storage media to register a digital medium and verify a registration of a digital medium.

### SUMMARY

I provide a method of registering a digital medium using a permissioned blockchain network, the method comprising: receiving, by at least one peer of a permissioned blockchain network, a digital medium from a medium provider and an identifier of the medium provider, wherein the digital medium comprises at least one of: a digital picture, a digital audio, and a digital video; executing, by the at least one peer, a smart contract to register the digital medium; verifying, by the at least one peer, the identifier of the medium provider using the smart contract; determining, by the at least one peer, a content identifier of the digital medium using the smart contract, wherein the content identifier is an identifier that uniquely identifies a content of the digital medium; generating, by the at least one peer, a registration identifier corresponding to the digital medium using the smart contract; storing, by the at least one peer, the registration identifier in a blockchain; and providing, by the at least one peer, the registration identifier and the content identifier to a database.

I also provide a method of verifying a registration of a digital medium using a permissioned blockchain network, the method comprising: receiving, by at least one peer of a permissioned blockchain network, a digital medium from a medium provider, wherein the digital medium comprises at least one of: a digital picture, a digital audio, and a digital video; executing, by the at least one peer, a smart contract to verify the registration of the digital medium in the permissioned blockchain network; determining, by the at least one peer, a content identifier of the digital medium using the smart contract, wherein the content identifier is an identifier that uniquely identifies a content of the digital medium; transmitting, by the at least one peer, the content identifier of the digital medium to the medium provider, wherein the content identifier is used by the medium provider to search a database for at least one stored content identifier corresponding to the determined content identifier and at least one corresponding registration identifier; receiving, by the at least one peer, the at least one registration identifier; determining, by the at least one peer, using the smart contract executed on the at least one peer, whether the at least one registration identifier is stored in a blockchain to verify the received at least one registration identifier, and transmitting, by the at least one peer, a result of the verification of the at least one registration identifier to the medium provider.

I further provide a system that registers a digital medium and/or verifies a registration of a digital medium, the system comprising a permissioned blockchain network comprising at least one peer and a database: wherein: the at least one peer is configured to receive a digital medium from a medium provider and an identifier of the medium provider, wherein the digital medium comprises at least one of: a digital picture, a digital audio, and a digital video, execute a smart contract to register the digital medium, verify the identifier of the medium provider using the smart contract, determine a content identifier of the digital medium using the smart contract, wherein the content identifier is an identifier that uniquely identifies a content of the digital medium, generate a registration identifier corresponding to the digital medium using the smart contract, store the registration identifier in a blockchain, and provide the registration identifier and the content identifier to the database; and the database is configured to store the registration identifier and the content identifier; and/or wherein: the at least one peer is configured to: receive a digital medium from a medium provider, wherein the digital medium comprises at least one of: a digital picture, a digital audio, and a digital video, execute a smart contract for verifying the registration of the digital medium in the permissioned blockchain network, determine a content identifier of the digital medium using the smart contract, wherein the content identifier is an identifier that uniquely identifies a content of the digital medium, transmit the content identifier of the digital medium to the medium provider; the database is configured to: receive the content identifier from the medium provider, search the database for at least one stored content identifier corresponding to the determined content identifier and at least one corresponding registration identifier, transmit the corresponding at least one registration identifier to the medium provider; and the at least one peer is further configured to: receive the at least one registration identifier from the medium provider, determine, using the smart contract executed on the at least one peer, whether the at least one registration identifier is stored in a blockchain to verify the received at least one registration identifier, and transmit a result of the verification of the at least one registration identifier to the medium provider.

I further yet provide the method of verifying a registration of a digital medium using a permissioned blockchain network, the method comprising: receiving, by at least one peer of a permissioned blockchain network, a digital medium from a medium provider, wherein the digital medium comprises at least one of: a digital picture, a digital audio, and a digital video; executing, by the at least one peer, a smart contract to verify the registration of the digital medium in the permissioned blockchain network; determining, by the at least one peer, a content identifier of the digital medium using the smart contract, wherein the content identifier is an identifier that uniquely identifies a content of the digital medium; transmitting, by the at least one peer, the content identifier of the digital medium to the medium provider, wherein the content identifier is used by the medium provider to search a database for at least one stored content identifier corresponding to the determined content identifier and at least one corresponding registration identifier; receiving, by the at least one peer, the at least one registration identifier; determining, by the at least one peer, using the smart contract executed on the at least one peer, whether the at least one registration identifier is stored in a blockchain to verify the received at least one registration identifier, and transmitting, by the at least one peer, a result of the verification of the at least one registration identifier to the medium provider, wherein the content identifier is an acoustic and/or a visual fingerprint of the digital medium.

### BRIEF DESCRIPTION OF THE DRAWINGS

FIG. 1 shows a flowchart of a method of registering a digital medium using a permissioned blockchain network according to a first example.

FIG. 2 shows a flowchart of a method of verifying a registration of a digital medium using a permissioned blockchain network according to the first example.

FIG. 3 shows a flowchart of a method of registering a digital medium using a permissioned blockchain network according to a second example.

FIG. 4 shows a flowchart of a method of verifying a registration of a digital medium using a permissioned blockchain network according to the second example.

FIG. 5 shows a system of registering a digital medium and verifying a registration of a digital medium.

### LIST OF REFERENCE SIGNS

31, 41 user
32, 42 client application
33, 43 peer
34, 44 smart contract
35, 45 database controller
36, 46 database
50 system
51 gateway application
52 user
53, 53′ peer
54 medium registry
55 database controller
56 database
100, 200 method
300, 400 method
S101-S107 steps
S201-S207 steps
301-311 steps
401-418 steps

### DETAILED DESCRIPTION

My method of registering a digital medium using a permissioned blockchain network comprises:
receiving, by at least one peer of a permissioned blockchain network, a digital medium from a medium provider and an identifier of the medium provider,
executing, by the at least one peer, a smart contract for registering the digital medium,
verifying, by the at least one peer, the identifier of the medium provider using the smart contract,
determining, by the at least one peer, a content identifier of the digital medium using the smart contract,
generating, by the at least one peer, a registration identifier corresponding to the digital medium using the smart contract,
storing, by the at least one peer, the registration identifier in a blockchain, and
providing, by the at least one peer, the registration identifier and the content identifier to a database.

A blockchain network is a technical infrastructure that provides ledger and smart contract (“chaincode”) services to applications. For example, smart contracts are used to generate transactions that may subsequently be distributed to every peer in the network where they are immutably recorded on their copy of the ledger, i.e., in a blockchain. The users of applications might be end users using client applications or blockchain network administrators.

Permissioned blockchain networks are blockchain networks that require access to be part of. In these blockchain types, a control layer runs on top of the blockchain that governs the actions performed by the allowed participants. For example, multiple organizations come together as a consortium to form the network and their permissions are determined by a set of policies that are agreed by the consortium. Alternatively, the network is set up by a single trusted authority, which governs the network.

The blockchain network is comprised of peers (“peer nodes”), each of which can hold copies of ledgers and copies of smart contracts. Peers can be created, started, stopped, reconfigured, and even deleted. They expose a set of application programming interfaces, APIs, that enable administrators and applications to interact with the services that they provide. The blockchain network is built up from the peers owned and contributed by the different organizations. Each peer has an identity assigned to them via a digital certificate from a particular certificate authority. For example, a peer may be implemented by software based on predefined specifications. For auditability, security, and/or trust reasons, open source implemented peers may be used. The deployment of a peer may be on-premise or on cloud, or on infrastructure provided by a third party or any combination thereof.

A digital medium in this context may be any kind of digital asset, for which proof of ownership shall be registered, and of which a content identifier can be determined. The digital medium may be, for example, any visual or auditory medium of a digital or real-world asset such as, for example, a picture of a visual artwork, a visual document, a piece of music or spoken words, a video and the like.

A content identifier may be an identifier that uniquely identifies a content of the digital medium. The content identifier is, for example, an acoustic and/or a visual fingerprint of the digital medium. For example, when a digital medium is a song, the content identifier may be an acoustic fingerprint of the song, for example, a deterministically generated time-frequency relation (i.e., a spectrogram) from an audio signal corresponding to the song. In a video, video fingerprinting or video hashing may be used, which are a class of dimension reduction techniques in which a software identifies, extracts, and then summarizes characteristic components of a video as a unique or a set of multiple perceptual hashes. If the digital medium is an image, any type of known visual recognition technique, with which a content of the image may uniquely be identified, e.g., a light per pixel spectrogram, may be used to obtain the content identifier.

Furthermore, in the step of determining a content identifier, also more than one, for example, three content identifier may be determined. Each determined content identifier may then be provided to the database, and the database may be searched by just one of the multiple or by several of the multiple content identifiers. In an image, for example, a first content identifier may be determined, which relates to a value by which a light of each pixel of the image differs from an average value of light of the entire or a part of the image, and, a second content identifier may be determined, which relates to a value by which a light of each pixel of the image differs from a light value of its neighboring pixels. For example, a trained artificial intelligence model may be used to determine which of the multiple content identifiers should be trusted most and how they are weighted, for a search of a matching database entry, with respect to each other.

In this context, the content identifier identifies the digital medium based on the content comprised in the digital medium itself (e.g., an artwork shown in an image or the music of a sound file) and not based on the digital file (e.g., metadata or hash of the file itself), in which it is comprised.

The medium provider, in this context, is the entity, which is providing the digital medium to the network, either for registration purposes or obtaining information regarding an ownership of a digital medium. The medium provider may be, for example, an electronic device using a gateway, a web application, or any other means through which a person or organization may provide the digital medium to the blockchain network. The identifier of the medium provider may be any identifier, which uniquely identifies the corresponding medium provider. For example, the identifier of the medium provider may be a signature of the medium provider, a cryptographic key, in particular a public key of the medium provider for asymmetric cryptography, or a cryptographically verifiable certificate, e.g., a certificate according to the X.509 standard.

The smart contract defines rules for the blockchain network in executable code. The peers may invoke a smart contract to generate transactions that are recorded on the ledger. Using the blockchain network, the smart contract, therefore, is implementing an executable program. The smart contract can implement governance rules so that they can be automatically enforced when the smart contract is executed.

In the example, by executing the smart contract, an algorithm is started, with which the identifier of the medium provider is verified and the content identifier of the digital medium is determined. Additionally, an identifier of the registration process, herein called the registration identifier, is generated. This registration identifier corresponds to the above-mentioned transactions, which are generated and recorded in the blockchain by executing the smart contract. The registration identifier uniquely identifies the registration process of a certain digital medium. The registration identifier can then be used to verify, whether the corresponding registration process was performed, by identifying whether it has been appended to the blockchain.

An advantage of the method is that a secure and reliable registration of the ownership of the digital medium is provided and, therefore, a secure and reliable way of proving an ownership of an asset shown or otherwise comprised in the digital medium is provided. Thereby, a reliability of the data of an external database as due to the cross-reference of the database's entries and blockchain entries is enhanced. Moreover, direct matches may be searched and retrieved directly from the blockchain due to the stored registration identifiers. Similarity based query may be performed by utilizing the external database for efficiency reasons. Similarity based queries may be implemented also on the smart contract application for some use-cases.

Moreover, my method also provides a rapid and easy to use method of registering such asset. In that the smart contract itself is used to authenticate the medium provider by verifying its identifier, determine the content identifier of the digital medium and generate the registration identifier, those tasks are linked together for additional security and a rapid processing.

A further advantage is that this method of registering the digital medium enables the blockchain network to further additional application possibilities, based on the registering process, which are described in more detail with regard to the attached figures. For example, while registering a digital medium, similar entries to the digital medium in the database may be queried and/or evaluated. Additionally or alternatively, different authentication procedures and/or permissions for the medium provider may be applied, which makes the registration method easily adaptable to different blockchain network architectures and/or security and implementation requirements. Moreover, with the method described herein, information regarding registered digital media may be easily and reliably retrieved.

The method may further comprise: determining whether the database comprises at least one content identifier identical and/or similar to the content identifier corresponding to the digital medium received from the medium provider according to a similarity threshold.

An advantage thereof is that, at the time of registering the digital medium, it can be checked whether an identical or similar asset has already been registered. This way, a reliability of the proof of ownership of the asset can be improved in that, for example, a notification can be generated either to the provider of the digital medium which shall be registered, or a provider of a digital medium which already has been registered, in an identical or similar asset has already been registered, thereby possibly detecting a fraudulent registration (either of the current registration process or of a previous, already existing registration).

The content identifier may further be propagated to at least one further peer of the permissioned blockchain network.

An advantage thereof is that a security of the determination of the content identifier with the smart contract may additionally be improved. For example, by propagating the content identifier from a first peer to other peers, it can be checked whether the content identifier determined by the first peer is determined correctly, i.e., whether the first peer determines the same content identifier as other peers of the network. When one peer determines a different content identifier than the other peers, the one peer might have been tempered with or might malfunction due to other reasons. According notifications may be generated, the first peer may be neglected or omitted from the network, or other measures may be taken.

The identifier of the medium provider may further be stored, by the at least one peer in the blockchain.

An advantage thereof is, for example, that the registrations of digital media may also be stored in the database with reference to the corresponding medium providers stored in the blockchain. This way, the blockchain then may be queried, for example, to provide results based on the medium provider, in digital media of a certain medium provider are of interest.

The method may further comprise: transmitting, by the at least one peer, a result of the registering of the digital medium to the medium provider.

This way, the medium provider can be notified, for example, by transmitting a “registration successful” message, whether the registration process has been successful. Additionally, for example, if the result of the registering process comprises also a notification concerning similar and/or identical results with regard to the content identifiers of the digital medium which the medium provider wishes to register, the medium provider can be notified accordingly and the medium provider can take additional steps to verify whether the digital medium which shall be registered, or whether other digital media already registered in the database and the blockchain were possibly registered fraudulently. Moreover, transmitting the result of the registering may also comprise transmitting the content identifier and/or the registration identifier to the medium provider such that the medium provider can store those for further references.

The method may further comprise: receiving, by the at least one peer, metadata corresponding to the digital medium, analyzing, by the at least one peer, the metadata, and providing, by the at least one peer, the metadata to the database.

An advantage thereof is that the additional metadata may provide additional possibilities to query the database based on such metadata. The metadata may comprise, for example, names of an originator of an asset comprised in the digital medium, a time of origination of the asset, a location of an origination of the asset, the aforementioned with regard to the digital medium itself, additional information of a file with which the digital medium is provided, i.e., a type of a file (.jpeg, .png, .pdf, .mp3, .mov, .wav and the like), a time of creation and/or modification, a size and the like. When those additional information is stored based on the metadata in the database, the database may be queried, for example, to find registrations from a certain composer, from a certain file-type, created at/before/after a certain time or the like

My method of verifying a registration of a digital medium using a permissioned blockchain network may comprise:
receiving, by at least one peer of a permissioned blockchain network, a digital medium from a medium provider,
executing, by the at least one peer, a smart contract for verifying the registration of the digital medium in the permissioned blockchain network,
determining, by the at least one peer, a content identifier of the digital medium using the smart contract,
transmitting, by the at least one peer, the content identifier of the digital medium to the medium provider, wherein the content identifier is used by the medium provider to search a database for at least one stored content identifier corresponding to the determined content identifier and at least one corresponding registration identifier,
receiving, by the at least one peer, the at least one registration identifier,
determining, by the at least one peer, using the smart contract executed on the at least one peer, whether the at least one registration identifier is stored in a blockchain to verify the received at least one registration identifier, and
transmitting, by the at least one peer, a result of the verification of the at least one registration identifier to the medium provider.

An advantage thereof is, that a secure and reliable method is provided, according to which a database may be queried to verify whether ownership of an asset, of which a digital medium is provided, has been registered in the blockchain network. With this method according to this second example, registrations which may have been performed according to the first example, may be easily and rapidly retrieved, based on a provided digital medium, and verified. This way, a registration identifier, which is found in the database due to an identity or similarity of the determined content identifier and at least one stored content identifier, may be verified by checking whether a corresponding registration identifier is stored in a blockchain.

When a corresponding registration identifier is found in the blockchain, it can be determined that at least one corresponding registration process for at least one digital medium, to which the at least one stored content identifier corresponds, was performed and has been registered in the blockchain. Accordingly, it can be determined that ownership of such digital medium has previously been registered.

If no stored content identifier matching the determined content identifier can be found in the database, it can be determined that ownership of a corresponding digital medium has not yet been registered in the blockchain network. If, however, at least one stored content identifier can be found in the database, but a verification of the corresponding registration identifier fails, it can be determined that an entry regarding ownership of the digital medium has been tempered with in the database.

Similar as explained with regard to the first example, also according to the second example, more than one content identifier may be used. If multiple content identifiers are stored in the database with respect to a digital medium, the database may be searched for a match of just one of the multiple content identifiers or may be searched for matches of more than one of the multiple content identifiers, e.g., based on a weighted importance of the content identifiers and/or based on respective thresholds.

Further advantages, as well as technical details and examples of the method according to the second example correspond to those of the method according to the first example and are not described herein again. The method according to the first example and the second example are computer implemented methods.

The transmitting, by the at least one peer, a result of the verification of the at least one registration identifier may further comprise: transmitting, by the at least one peer, at least one identifier of at least one medium provider corresponding to the at least one registration identifier.

An advantage thereof is that not only can it be determined whether a registration existed, but also which medium provider registered an ownership of the registered digital medium.

The at least one content identifier corresponding to the determined content identifier may be at least one content identifier, which is identical and/or similar to the determined content identifier.

An advantage thereof is that not only registrations of identical digital media can be verified, but also registrations can be found, which have a certain similarity, for example, determined by a similarity threshold, according to which a level of similarity between a provided digital medium and information regarding registered digital media can be defined. For example, all content identifiers stored in the database which have a similarity higher than such similarity threshold are returned as matching content identifier entries from the database.

This is in particular advantageous if certain modifications have been performed to the digital medium, which should, however, still be considered matching a corresponding unmodified version. For example, if the digital medium is a digital picture and a contrast and/or brightness and/or colorization of the digital picture has been changed, a similarity threshold could be defined, which still would find corresponding content identifiers of the changed and unchanged digital pictures as matching entries in the database. Further, if the digital medium is a picture of a real-world sculpture or painting, for example, for which ownership is registered in the blockchain network, pictures of the sculpture or painting might be taken with different devices and/or from different angles, which may result in a certain difference between the corresponding digital media. By determining also similar content identifiers as matching content identifiers, such differences may be accepted in the verification process, and results concerning similar assets may be returned.

My system of registering a digital medium comprises a permissioned blockchain network. The permissioned blockchain network comprises at least one peer and a database. The at least one peer is configured to receive a digital medium from a medium provider and an identifier of the medium provider, execute a smart contract to register the digital medium, verify the identifier of the medium provider using the smart contract, determine a content identifier of the digital medium using the smart contract, generate a registration identifier corresponding to the digital medium using the smart contract, store the registration identifier in a blockchain, and provide the registration identifier and the content identifier to the database. The database is configured to store the registration identifier and the content identifier.

My system of verifying a registration of a digital medium comprises a permissioned blockchain network comprising at least one peer and a database. The at least one peer is configured to: receive a digital medium from a medium provider, execute a smart contract for verifying the registration of the digital medium in the permissioned blockchain network, determine a content identifier of the digital medium using the smart contract, and transmit the content identifier of the digital medium to the medium provider. The database is configured to: receive the content identifier from the medium provider, search the database for at least one stored content identifier corresponding to the determined content identifier and at least one corresponding registration identifier, and transmit the corresponding at least one registration identifier to the medium provider. The at least one peer is further configured to: receive the at least one registration identifier from the medium provider, determine, using the smart contract executed on the at least one peer, whether the at least one registration identifier is stored in a blockchain to verify the received at least one registration identifier, and transmit a result of the verification of the at least one registration identifier to the medium provider.

My computer program comprises instructions which, when executed by at least one processor, make the at least one processor perform the method according to the first or second example.

My computer-readable storage medium comprises the computer program according to the fifth example.

Advantages and configurations of the third to sixth examples correspond to those described with respect to the first and second examples and are not repeated herein again. Moreover, any features described with regard to one of the examples can be readily combined with any of the other examples.

Further advantages are disclosed in the appended claims as well as the following detailed description of examples. The examples are described with respect to the attached figures.

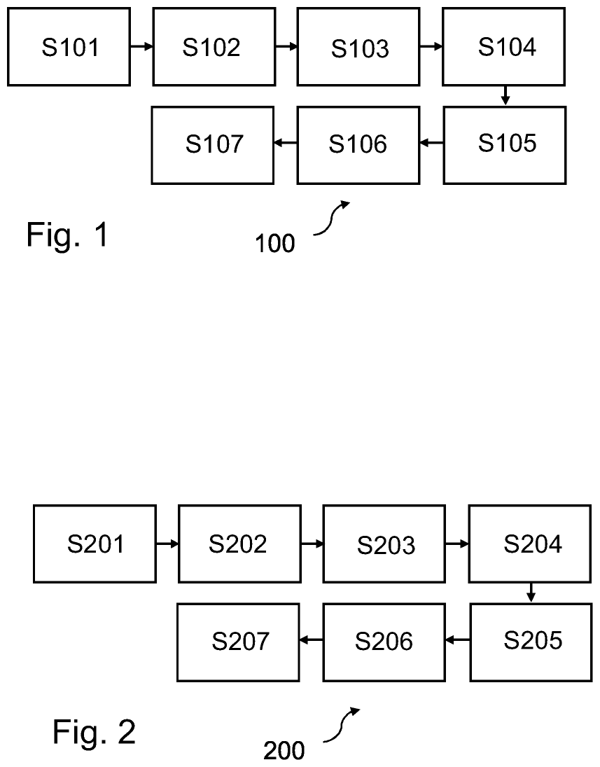

FIG. 1 shows a flowchart of a method 100 of registering a digital medium using a permissioned blockchain network according to a first example. Registering the digital medium in this context means registering the content of the digital medium based on its content identifiers, as described below.

In one step S101, at least one peer of a permissioned blockchain network receives a digital medium from a medium provider. The at least one peer further receives an identifier of the medium provider from the medium provider together with the digital medium. The identifier may either be an explicit identifier of the medium provider, transmitted together with the digital medium, or may be an implicit identifier, derived from a cryptographic key of the medium provider or other identification means.

In another step S102, the at least one peer executes a smart contract for registering the digital medium, which has been received in step S101. If multiple peers execute the smart contract, each peer executes the same smart contract individually. The smart contract comprises algorithms implementing tasks that need to be performed by the at least one peer to register the digital medium such as described in the following steps.

In another step S103, the at least one peer verifies the identifier of the medium provider in the smart contract. Hereby, the at least one peer verifies, using the smart contract, whether the identifier of the medium provider is valid. For example, if only certain medium providers are accepted, it is verified whether the medium provider providing the digital medium and the identifier is such an allowed medium provider.

In another step S104, the at least one peer determines a content identifier of the digital medium in the smart contract. Herein, the smart contract runs a content identification on the digital medium to identify the content identifier. For example, if the digital medium is a sound file, an acoustic fingerprint of the sound file is generated. If, for example, the digital medium is an image, a light-per-pixel spectrum may be generated. Other content identification processes are, of course, possible.

In another step S105, the at least one peer generates a registration identifier corresponding to the digital medium in the smart contract. The registration identifier is in the scope of the blockchain network a globally unique identifier of the registration process. One possibility to generate the registration identifier is to generate the registration identifier based on the actual transaction identifier, which is generated according to a blockchain protocol. Alternatively, the registration identifier may be generated independently from the blockchain transaction identifier. Further possibilities to generate the unique registration identifier, however, are of course also possible.

In another step S106, the at least one peer stores the registration identifier in a blockchain. Storing the registration identifier in the blockchain may be initiated or executed by the smart contract. Before storing the registration identifier in the blockchain, the registration identifier may be propagated to and checked at further peers, in particular to such further peers, which also executed the smart contract and generated the registration identifier.

In another step S107, the at least one peer provides the registration identifier and the content identifier to a database. The database may then store the registration identifier with the corresponding content identifier for subsequent queries.

FIG. 2 shows a flowchart of a method 200 for verifying a registration of a digital medium using a permissioned blockchain network according to a first example. For example, the method 200 as shown in FIG. 2 may be used to query database entries as generated with method 100 as shown in FIG. 1.

In one step S201, at least one peer of a permissioned blockchain network receives a digital medium from a medium provider. Optionally, the at least one peer may also receive an identifier of the medium provider.

In another step S202, the at least one peer executes a smart contract of verifying the registration of the digital medium in the permissioned blockchain network. Optionally, if the at least one peer also received the identifier of the medium provider, the identifier of the medium provider may be verified in the smart contract, equally as performed in step S103 of method 100 shown in FIG. 1. For the query process, however, the verification of the identifier of the medium provider is not obligatory, if requests from un-identified entities are also allowed.

In another step S203, the at least one peer determines a content identifier of the digital medium using the smart contract. The step may be performed identical to step S104 of method 100 as shown in FIG. 1.

In another step S204, the at least one peer transmits the content identifier of the digital medium, determined in step S203, to the medium provider. The medium provider is thereby enabled to query a database for at least one stored content identifier matching the determined content identifier. Additionally, the medium provider is enabled to receive at least one registration identifier from the database, which is stored together with the at least one content identifier.

In another step S205, the at least one peer receives the at least one registration identifier, which was found in the database in step S204, and which belongs to the at least one stored content identifier matching the content identifier determined in step S203. The at least one peer receives the registration identifier from the medium provider.

In another step S206, the at least one peer verifies the at least one registration identifier in the smart contract executed on the at least one peer. This verification is performed by checking, whether a matching registration identifier can be found in a blockchain, in which registration identifiers are stored, for example, as described with respect to step S106 regarding FIG. 1.

In another step S207, the at least one peer transmits a result of the verification of the at least one registration identifier to the medium provider. If the registration identifier was not able being verified, i.e., no matching registration identifier could be found stored in the blockchain, a result of the verification could be that the data base entry, from which the at least one registration identifier was obtained, has been erroneous, e.g., has been tempered with. If a matching registration identifier was found in the blockchain, a result of the verification could be that the digital medium, which was provided in step S201, was previously registered in the permissioned blockchain network. In the latter example, merely a notification regarding a verified registration could be returned in step S207, or further corresponding information could be provided such as, for example, an identifier of the medium provider that originally registered the digital medium in the blockchain network, and/or further metadata such as described in other parts of this application.

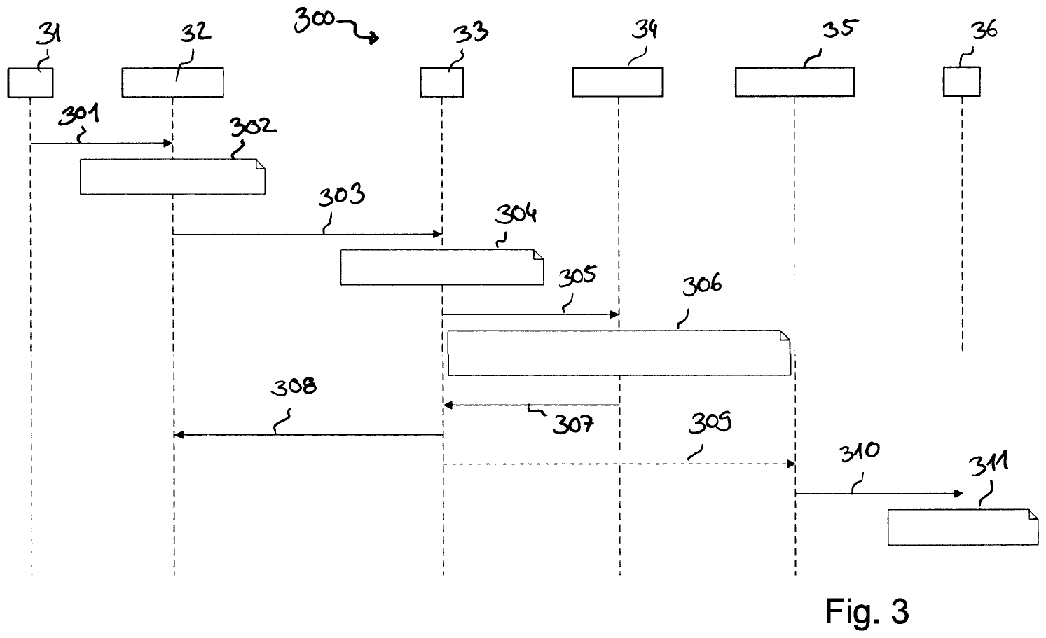

FIG. 3 shows a flowchart of a method 300 of verifying a registration of a digital medium using a permissioned blockchain network according to a second example.

In one step 301, a user 31 submits a digital medium with metadata for registration to a client application 32. The digital medium may be a picture, a sound file, or a video of a digital or real-world asset such as, for example, a painting, a sculpture, a document, a song, spoken words or the like. The user 31 may use any electronic device, which the user can use to provide such digital medium. For example, the user 31 may use a smartphone, tablet computer, laptop, desktop computer, wearable and the like. The metadata may comprise, for example, information regarding the asset such as an asset name, and originators name, information regarding a file type of the digital medium, a time of creation of the asset and/or the digital medium or the like.

The client application 32 may be, for example, an application, which runs on a personalized user device of the user 31, or may be a web application, which the user can access, for example, with a personalized profile. Alternatively, the client application 32 may be an openly accessible application, to which, for example, an identification of the user who provides the digital medium, can be entered.

In another step 302, the client application 32 processes the digital medium and the metadata received in step 301. For example, the client application 32 may verify a type of the digital medium (such as picture/song/filetype/etc.) Further, the client application 32 may perform API validation and pack the received data to forward it via its API. The client application 32 generates a transaction payload, i.e., a data packet comprising the digital medium and the metadata. The client application 32 and the user 31 may be regarded as medium provider in this example.

In another step 303, the client application 32 signs the transaction payload with a cryptographic key of the client application 32 and sends the signed transaction payload to a peer 33 of a permissioned blockchain network. By sending the signed transaction payload to the peer 33, the client application 32 initiates a request to execute a smart contract for registration on the peer 33. In this example, I refer to only one peer. However, instead of only using one peer 33, also multiple peers of the permissioned blockchain network may be used.

In this example, as shown in FIG. 3, an identifier of the user that provides the digital medium is provided to the peer 33 by signing the transaction payload with the cryptographic key of the client application 32. Other ways of providing such identifier of the medium provider, however, are of course also possible. If the client application 32 is, for example, a web application, the identifier of the medium provider may be, for example, related to an account of a user 31 for the web application, or may be entered by the user 31 via the web application.

In another step 304, the peer 33 decrypts the signed transaction payload. The peer 33, therefore, obtains the digital medium, the metadata and the identifier of the medium provider.

In another step 305, the peer 33 requests execution of a smart contract 34 for registering the digital medium in the blockchain network.

When the smart contract 34 is executed, the smart contract 34 verifies an identity of the medium provider in a step 306 based on the identifier of the medium provider received by the peer 33. In a permissioned blockchain network, a governing entity or consortium of entities provides policies for the blockchain network. With those policies, for example, rules are provided, regarding which entities are allowed to provide digital media for registration. In step 306, therefore, the smart contract 34 may verify the identity of the medium provider by enforcing those policies.

Furthermore, in step 306, the smart contract 34 analyzes the digital medium and generates a content identifier (also called fingerprint) of the digital medium as described in other parts of this application.

The smart contract 34 then further generates a registration identifier which identifies the transactions of this registration process.

In another step 307, the smart contract 34 stores the registration identifier in a blockchain of the blockchain network by appending the transaction to a ledger of the peer 33. Alternatively to directly appending the transaction to the ledger of the peer 33, step 307 may comprise several sub-steps, not shown herein: after generating the registration identifier, the peer 33 transmits an endorsement message to the client application 32, informing the client application 32 that the transaction has been successfully generated, including the transaction data. The client application 32 then sends the transaction data with the endorsement message to an ordering service, not shown herein. The ordering service is preferably a peer of the blockchain network, different from peers which may generate transaction data. The ordering service verifies the transaction data and, if the verification is successful, orders the transaction identifier into a block, and sends the block for registration to the peer 33. Once the peer 33 receives the block from the ordering service, the peer 33 then verifies that a corresponding endorsement for the transaction exists, validates the transaction identifier, and appends the block comprising the registration identifier corresponding to the transaction data to the blockchain. Alternatively to using the same peer 33 to generate the transaction and endorsement message and appending the block to the blockchain, different peers may be used for that. An endorsement peer, generating the transaction and endorsement message, and a committing peer, appending the received block to the blockchain. This may achieve an even higher level of security.

Afterwards, the peer 33 provides a “registration succeeded” message to the client application 32 in step 308. Optionally, with that “registration succeeded” message, the registration identifier may be provided to the client application 32, such that the client application 32 has verifiable proof of its requested and successfully performed registration of the provided digital medium.

Additionally, the peer 33 provides the transaction event data, i.e., the registration identifier, the content identifier, the identifier of the medium provider and the metadata to a database controller 35 in a step 309. To do so, the database controller 35 connects to the peer 33 to intercept new transaction events. For example, the database controller 35 is an application of a client connected to the peer 33 or an external application communicating through a client connected to the peer 33, wherein the client may be the client application 32 or a different client. The database controller 35 may instruct the peer to provide the database controller 35 with a notification once new transaction event data are available such that the database controller 35 can obtain the corresponding data from the peer 33.

The database controller 35 persists the transaction event data, i.e., creates from the intercepted transaction event data corresponding information to be registered in a database 36, to enable querying of the corresponding data in a step 310 and forwards the data to the database 36.

The database 36 then stores the transaction event data received from the database controller 35 in the database 36 in a step 311. In particular, the registration identifier and the content identifier are stored in the database 36. Additionally, also the metadata, the identifier of the medium provider, a copy of the digital medium itself, or other related data may be stored in the database 36.

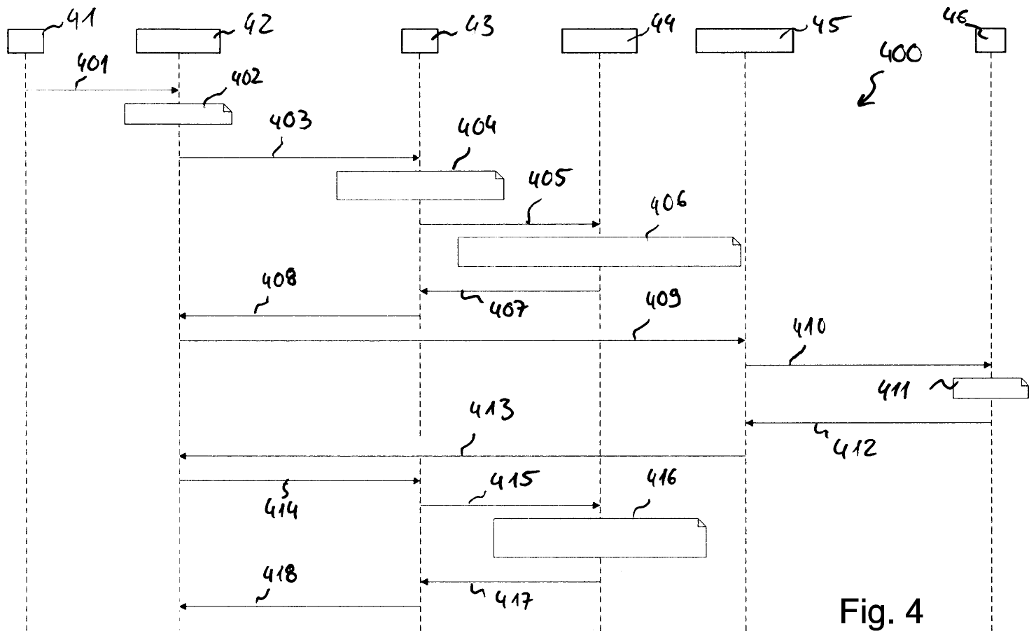

FIG. 4 shows a flowchart of a method 400 of verifying a registration of a digital medium using a permissioned blockchain network according to a second example.

In one step 401, a user 41 provides a digital medium to a client application 32. Additionally, the user 41 may define a similarity threshold, which defines, how much a digital medium corresponding to a stored entry in a database may differ from the digital medium provided by the user 41, while still being determined as a match for the digital medium provided to the client application 32.

In a step 402, the digital medium is processed by the client application 42. The client application 42 generates a transaction payload, i.e., a data packet comprising the digital medium and the metadata.

The client application 42 then signs the transaction payload with a cryptographic key of the client application 42 in a step 403 and sends the signed transaction payload to a peer 43 of a permissioned blockchain network. By sending the signed transaction payload to the peer 43, the client application 42 initiates a request to execute a smart contract to analyze the provided digital medium on the peer 43, i.e., verify whether an identical or similar digital medium has been correctly registered in the blockchain network. In this example, I refer to only one peer 43. However, instead of only using one peer 43, also multiple peers of the permissioned blockchain network may be used.

In another step 404, the peer 43 decrypts the signed transaction payload. The peer 43, therefore, obtains the digital medium and the identifier of the medium provider. The identifier of the medium provider may be obtained corresponding to the process described with respect to method 300.

In another step 405, the peer 43 requests execution of a smart contract 44 that analyzes the digital medium in the blockchain network.

When the smart contract 44 is executed, the smart contract 44 verifies an identity of the medium provider in a step 406 based on the identifier of the medium provider received by the peer 43. The verification of the identifier of the medium provider may be performed corresponding to the process as described with respect to method 300.

Furthermore, in step 406, the smart contract 44 analyzes the digital medium and generates content identifiers (fingerprints) of the digital medium as described in other parts of this application. The generation of the content identifier may be performed identical to that described with respect to method 300.

The smart contract 44 may optionally further generate a transaction identifier which identifies the transactions of this analyzation process. The generation of the transaction identifier may correspond to the generation of the registration identifier as described with respect to method 300.

In another step 407, the smart contract 44 optionally stores the transaction identifier in a blockchain of the blockchain network by appending the transaction to a ledger of the peer 43. The blockchain, to which the transaction identifier is appended may be the same or a different blockchain as the blockchain, in which the registration identifiers are stored.

In a further step 408, the peer 43 transmits the determined content identifier to the client application 42.

The client application 42 then transmits in a step 409 the content identifier and the similarity threshold defined by the user 41 in step 401 to a database controller 45, to initiate searching a database 46 for corresponding stored content identifiers.

In a step 410, the database controller 45 requests the database 46 to execute a query based on the provided content identifier and similarity threshold.

The database 46 executes a query in a step 411 to find stored entries in the database 46, which match the provided content identifier considering the similarity threshold.

The database 46 then returns to the database controller 45 in a step 412 registration identifiers corresponding to matched entries of the content identifier. With other words, the database 46 returns all registration identifiers, which correspond to content identifiers in the database, which are identical or, in view of the similarity threshold, similar enough to the provided content identifier to be considered a match regarding the content of the provided digital medium.

In a further step 413, the database controller 45 transmits the retrieved registration identifiers to the client application 42.

In a further step 414, the client application 42 transmits a request to verify the registration identifiers received from the database controller 45 to the peer 43. To request set verification from the peer 43, the client application 42 transmits the registration identifiers that were received in step 413 to the peer 43.

In a further step 415, the peer 43 initiates execution of a smart contract 44 to request a verification of the received registration identifiers.

In a further step 416, the smart contract 44 verifies an identity of the provider of the registration identifiers and retrieves registration identifiers corresponding to the registration identifiers obtained from the client application 42 from a blockchain, in which the registration identifiers are stored, for example, as described with respect to method 300.

In a further step 417, the smart contract 44 then returns a response to the peer 43. If no registration identifiers stored the blockchain corresponding to the provided registration identifiers was found by the smart contract 44, a response may be, that no corresponding registration transaction existed, and that the corresponding entries in the database 46 must have been erroneous. If registration identifiers are found in the blockchain, which correspond to the provided registration identifiers, the smart contract 44 returns a positive response to the peer 43, for example, declaring that corresponding registration transactions existed. Optionally, the smart contract 44 further transmits ledger data to the peer 43 with the response.

In a further step 418, the peer 43 returns a response regarding the verified or non-verified registration to the client application 42. This way, the user, who provided the digital medium to find out whether the same or a corresponding similar digital medium has been registered in the blockchain network receives a reliable and secure response whether such registration entry exists in the database 46 and whether a corresponding registration transaction can be verified based on the blockchain or not.

User 41, client application 42, peer 43, smart contract 44, database controller 45, and database 46 may correspond to those described with respect to FIG. 3. However, in particular user 41, client application 42, peer 43 and smart contract 44 may also be different from the corresponding user 31, client application 32, peer 33, and smart contract 34.

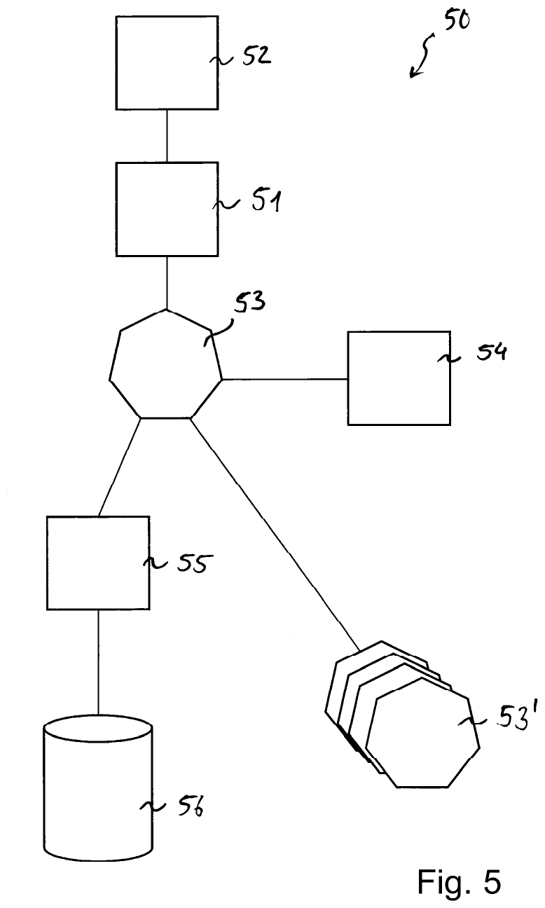

FIG. 5 shows a system 50 of registering a digital medium and verifying a registration of a digital medium in a permissioned blockchain network.

The system 50 comprises a gateway application 51, via which a user 52 may provide a digital medium, comprising content which the user 52 wishes to register or wishes to query a database regarding previous registrations with.

The system 50 further comprises a peer 53, in this example a peer of a hyperledger fabric permissioned blockchain network.

To register a digital medium, the peer 53 is configured to receive a digital medium from the gateway application 51 from the user 52 and an identifier of the user 52. The peer 53 is further configured to execute a smart contract for registering the digital medium.

In the system 50 shown in FIG. 5, the smart contract may be stored in a medium registry 54 of the system 50. The peer 53 is configured to verify the identifier of the user 52 in the smart contract, determine a content identifier of the digital medium in the smart contract, generate a registration identifier corresponding to the digital medium in the smart contract, and store the registration identifier in a blockchain. The registration identifier may be stored on a ledger of the peer 53 itself and/or may be propagated to other peers 53′ of the system 50.

The peer 53 is further configured to provide the registration identifier and the content identifier to a database controller 55, which is connected to a database 56 of the system 50. The database controller 55 may be implemented on a client of the blockchain network or may be communicating with the blockchain network through such client, which then serves as a gateway for the database controller 55. The database controller 55 may communicate with the peer 53, for example, through an API. The database 56 is configured to store the registration identifier and the content identifier.

To verify a registration of a digital medium, the peer 53 is configured to receive a digital medium from the gateway application 51 from the user 52, execute a smart contract for verifying the registration of the digital medium in the permissioned blockchain network, and determine a content identifier of the digital medium using the smart contract. The peer 53 is further configured to transmit the content identifier of the digital medium to the gateway application 51.

The database controller 55 is configured to receive the content identifier from the gateway application 51, search the database 56 for at least one stored content identifier corresponding to the determined content identifier and at least one corresponding registration identifier, and transmit the corresponding at least one registration identifier to the gateway application 51.

The peer 53 is further configured to receive the at least one registration identifier from the gateway application 51, verify the at least one registration identifier in the smart contract, and transmit a result of the verification of the at least one registration identifier to the gateway application 51.

Technical and implementation details, which are described with regard to any of the figures or the examples above, correspondingly apply to any other of the examples described herein and are not repeated in detail.

1-14. (canceled)

15. A method of registering a digital medium using a permissioned blockchain network, the method comprising:
receiving, by at least one peer of a permissioned blockchain network, a digital medium from a medium provider and an identifier of the medium provider, wherein the digital medium comprises at least one of: a digital picture, a digital audio, and a digital video,
executing, by the at least one peer, a smart contract to register the digital medium,
verifying, by the at least one peer, the identifier of the medium provider using the smart contract,
determining, by the at least one peer, a content identifier of the digital medium using the smart contract, wherein the content identifier is an identifier that uniquely identifies a content of the digital medium,
generating, by the at least one peer, a registration identifier corresponding to the digital medium using the smart contract,
storing, by the at least one peer, the registration identifier in a blockchain, and
providing, by the at least one peer, the registration identifier and the content identifier to a database.

16. The method according to claim 15, further comprising:
determining whether the database comprises at least one content identifier identical and/or similar to the content identifier corresponding to the digital medium received from the medium provider.

17. The method according to claim 15, wherein the content identifier is further propagated to at least one further peer of the permissioned blockchain network.

18. The method according to claim 15, wherein further the identifier of the medium provider is stored, by the at least one peer, in the blockchain.

19. The method according to claim 15, wherein the method further comprises:
transmitting, by the at least one peer, a result of the registering of the digital medium to the medium provider.

20. The method according to claim 15, further comprising:
receiving, by the at least one peer, metadata corresponding to the digital medium,
analyzing, by the at least one peer, the metadata, and
providing, by the at least one peer, the metadata to the database.

21. A method of verifying a registration of a digital medium using a permissioned blockchain network, the method comprising:
receiving, by at least one peer of a permissioned blockchain network, a digital medium from a medium provider, wherein the digital medium comprises at least one of: a digital picture, a digital audio, and a digital video,
executing, by the at least one peer, a smart contract to verify the registration of the digital medium in the permissioned blockchain network,
determining, by the at least one peer, a content identifier of the digital medium using the smart contract, wherein the content identifier is an identifier that uniquely identifies a content of the digital medium,
transmitting, by the at least one peer, the content identifier of the digital medium to the medium provider, wherein the content identifier is used by the medium provider to search a database for at least one stored content identifier corresponding to the determined content identifier and at least one corresponding registration identifier,
receiving, by the at least one peer, the at least one registration identifier,
determining, by the at least one peer, using the smart contract executed on the at least one peer, whether the at least one registration identifier is stored in a blockchain to verify the received at least one registration identifier, and
transmitting, by the at least one peer, a result of the verification of the at least one registration identifier to the medium provider.

22. The method according to claim 21, wherein the transmitting, by the at least one peer, a result of the verification of the at least one registration identifier further comprises:
transmitting, by the at least one peer, at least one identifier of at least one medium provider corresponding to the at least one registration identifier.

23. The method according to claim 21, wherein the at least one content identifier corresponding to the determined content identifier is at least one content identifier, which is identical and/or similar to the determined content identifier according to a similarity threshold.

24. A system that registers a digital medium and/or verifies a registration of a digital medium, the system comprising a permissioned blockchain network comprising at least one peer and a database, wherein:
the at least one peer is configured to receive a digital medium from a medium provider and an identifier of the medium provider, wherein the digital medium comprises at least one of: a digital picture, a digital audio, and a digital video, execute a smart contract to register the digital medium, verify the identifier of the medium provider using the smart contract, determine a content identifier of the digital medium using the smart contract, wherein the content identifier is an identifier that uniquely identifies a content of the digital medium, generate a registration identifier corresponding to the digital medium using the smart contract, store the registration identifier in a blockchain, and provide the registration identifier and the content identifier to the database; and
the database is configured to store the registration identifier and the content identifier; and/or wherein:
the at least one peer is configured to: receive a digital medium from a medium provider, wherein the digital medium comprises at least one of: a digital picture, a digital audio, and a digital video, execute a smart contract for verifying the registration of the digital medium in the permissioned blockchain network, determine a content identifier of the digital medium using the smart contract, wherein the content identifier is an identifier that uniquely identifies a content of the digital medium, transmit the content identifier of the digital medium to the medium provider;
the database is configured to: receive the content identifier from the medium provider, search the database for at least one stored content identifier corresponding to the determined content identifier and at least one corresponding registration identifier, transmit the corresponding at least one registration identifier to the medium provider; and
the at least one peer is further configured to: receive the at least one registration identifier from the medium provider, determine, using the smart contract executed on the at least one peer, whether the at least one registration identifier is stored in a blockchain to verify the received at least one registration identifier, and transmit a result of the verification of the at least one registration identifier to the medium provider.

25. The method according to claim 15, wherein the content identifier is an acoustic and/or a visual fingerprint of the digital medium.

26. The method according to claim 21, wherein the content identifier is an acoustic and/or a visual fingerprint of the digital medium.

27. The system according to claim 24, wherein the content identifier is an acoustic and/or a visual fingerprint of the digital medium.

28. The method according to claim 15, wherein the registration identifier is a unique identifier of the registration process of the digital medium.

29. The method according to claim 21, wherein the registration identifier is a unique identifier of the registration process of the digital medium.

30. The system according to claim 24, wherein the registration identifier is a unique identifier of the registration process of the digital medium.
